(19) United States
(12) Patent Application Publication
(10) Pub. No.: US 2025/0108650 A1
(43) Pub. Date: Apr. 3, 2025

(54) THERMAL PRINTER AND LOCKING MECHANISM

(71) Applicant: Nippon Printer Engineering Inc., Yamanashi (JP)

(72) Inventor: Kouki EMORI, Yamanashi (JP)

(73) Assignee: Nippon Printer Engineering Inc., Yamanashi (JP)

(21) Appl. No.: 18/935,628

(22) Filed: Nov. 3, 2024

Related U.S. Application Data
(63) Continuation of application No. PCT/JP2024/005951, filed on Feb. 20, 2024.

(30) Foreign Application Priority Data
Sep. 28, 2023 (JP) 2023-168842

(51) Int. Cl. B41J 29/13; B41J 2/32; B41J 11/04; E05C 3/00; E05C 3/30

(52) U.S. Cl. CPC B41J 29/13; B41J 2/32; B41J 11/04; E05C 3/008; E05C 3/30

(57) ABSTRACT

A thermal printer includes a housing, a head cover, and a locking mechanism, wherein the locking mechanism includes a lever member and a lock member which are configured so that i) as an operation part is pressed down, the lock member rotates in a direction to move a claw away from the lock pin, and a lock is released by the claw being disengaged from the lock pin and ii) as the operation part of the lever member is pulled up, a portion of the lever member presses the lock member, whereby the lock member rotates in a direction to move the claw away from the lock pin, and the lock is released by the claw being disengaged from the lock pin.

### CROSS-REFERENCE TO RELATED APPLICATIONS

The present application is a continuation application of International Application number PCT/JP2024/005951, filed on Feb. 20, 2024, which claims priority under 35 U.S.C § 119 (a) to Japanese Patent Application No. 2023-168842, filed on Sep. 28, 2023. The contents of these applications are incorporated herein by reference in their entirety.

### BACKGROUND OF THE INVENTION

The present disclosure relates to a thermal printer and a locking mechanism.

Conventionally, KIOSK terminals, POS terminals, and ticket issuing machines are equipped with a printer as an output device. Japanese Unexamined Patent Application Publication No. 2013-233690 discloses a structure in which a sheet drawn from a roll is sandwiched between a housing and a cover in a printing mechanism of a printer. Conventionally, in this type of printer, a mechanism is provided to lock the cover to the housing with the sheet set. By operating the lever of this mechanism, the lock is released, and the cover opens.

However, the conventional configuration has a problem in that an operation for releasing the lock is difficult to perform.

### BRIEF SUMMARY OF THE INVENTION

The present disclosure focuses on this point, and an object thereof is to provide a thermal printer and a locking mechanism that allow an operation for releasing a lock of a cover member, which is provided to be opened and closed, to be easily performed.

A first aspect of the present disclosure provides a thermal printer that includes a thermal head that performs printing on a long sheet drawn from a roll, a platen roller that i) is located at an opposing side with respect to the thermal head with the sheet interposed between the platen roller and the thermal head and ii) feeds the sheet, a housing that holds the platen roller so that the platen roller can rotate, a cover that i) holds the thermal head, ii) is coupled to the housing so that the cover can be opened and closed about a pivot point at one side along the sheet in a width direction, and iii) is provided so as to move between a closed position where the thermal head contacts the platen roller and an opened position where the thermal head is separated from the platen roller, and a locking mechanism that locks the cover to the housing, wherein the locking mechanism includes a lever member that is rotatably supported by the cover and is formed with an operation part operated by an operator, and a lock member, rotatably supported by the housing and formed with a claw engaging a lock pin of the cover, that maintains the cover in the closed position with the claw engaging the lock pin, and the lever member and the lock member are configured so that i) as the operation part is pressed down, the lock member rotates in a direction to move the claw away from the lock pin, and the lock is released by the claw being disengaged from the lock pin and ii) as the operation part of the lever member is pulled up, a first contact part which is a portion of the lever member presses the lock member, whereby the lock member rotates in a direction to move the claw away from the lock pin, and the lock is released by the claw being disengaged from the lock pin.

A second aspect of the present disclosure provides a locking mechanism for locking a cover to a housing in a printing device, the printing device including i) the housing that holds one of a thermal head and a platen roller for printing on a sheet and ii) a cover that holds another of the thermal head and the platen roller, and is coupled to the housing so that the cover can be opened and closed about a pivot point at one side along a sheet in a width direction, the locking mechanism includes a lever member that is rotatably supported by the cover and is formed with an operation part operated by an operator, and a lock member that is rotatably supported by the housing, is formed with a claw engaging a lock pin of the cover, and maintains the cover in a closed position with the claw engaging the lock pin, wherein the lever member and the lock member are configured so that i) as the operation part is pressed down, the lock member rotates in a direction to move the claw away from the lock pin, and the lock is released by the claw being disengaged from the lock pin and ii) as the operation part of the lever member is pulled up, a portion of the lever member presses the lock member, whereby the lock member rotates in a direction to move the claw away from the lock pin, and the lock is released by the claw being disengaged from the lock pin.

A locking mechanism of an aspect of the present disclosure is a locking mechanism for locking a second member to a first member, including a lever member that is rotatably supported by the second member and is formed with an operation part operated by an operator, and a lock member that is rotatably supported by the first member and is formed with a claw engaging with a first shaft of the second member, and maintains the second member in a closed position with the claw engaging the first shaft, wherein the lever member and the lock member are configured so that (i) from the locked state in which the claw engages the first shaft, as the operation part of the lever member moves in a first direction, the lock member rotates in a direction to move the claw away from the first shaft and the lock is released by the claw being disengaged from the first shaft, and (ii) as the operation part of the lever member moves in a second direction opposite to the first direction, a portion of the lever member presses the lock member, whereby the lock member rotates in a direction to move the claw away from the first shaft and the lock is released by the claw being disengaged from the first shaft.

According to the present disclosure, it is possible to provide a thermal printer and a locking mechanism that allow an operation for releasing a lock of a cover member, which is provided to be opened and closed, to be easily performed.

### BRIEF DESCRIPTION OF THE DRAWINGS

FIG. 1 is a perspective view showing a configuration of a thermal printer according to an embodiment of the present disclosure.

FIG. 2 is a front view showing a state in which a head cover is opened.

FIG. 3 is a diagram schematically illustrating FIG. 2.

FIG. 4 is a perspective view showing a peripheral structure of a locking mechanism.

FIG. 5 is an enlarged view showing the peripheral structure of the locking mechanism.

FIGS. 6A and 6B are perspective views of a lever member.

FIGS. 7A and 7B are perspective views of a lock member.

FIGS. 8A to 8D illustrate a locking action of the locking mechanism.

FIGS. 9A to 9D illustrate a first operation for releasing a lock.

FIGS. 10A to 10D illustrate a second operation for releasing the lock.

FIG. 11 shows a modification of the locking mechanism.

FIG. 12 schematically shows another usage example of the locking mechanism according to the present disclosure.

FIG. 13 is a schematic diagram illustrating another configuration example of the example of FIG. 12.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

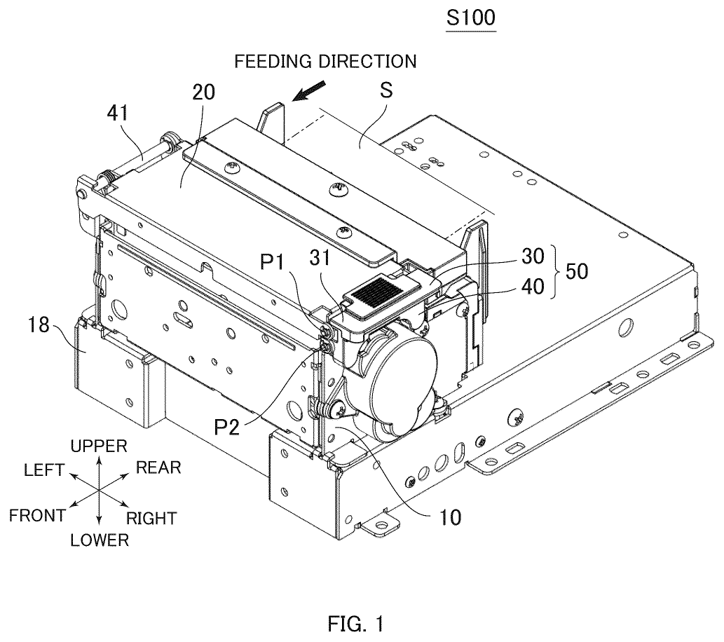

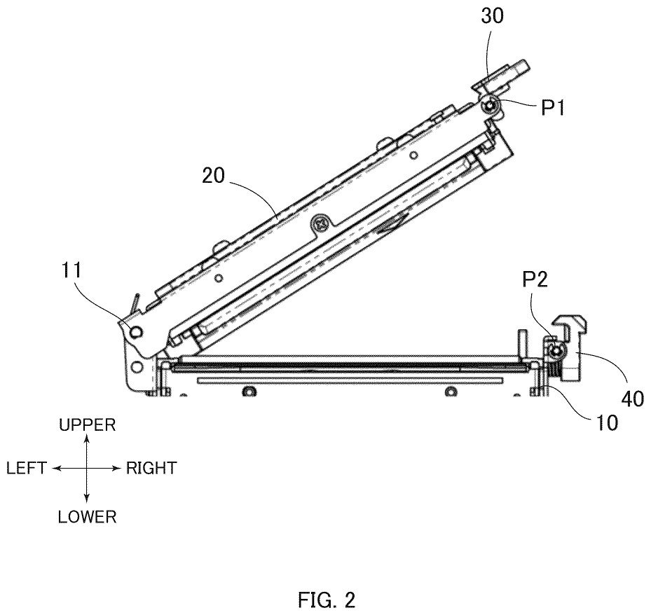

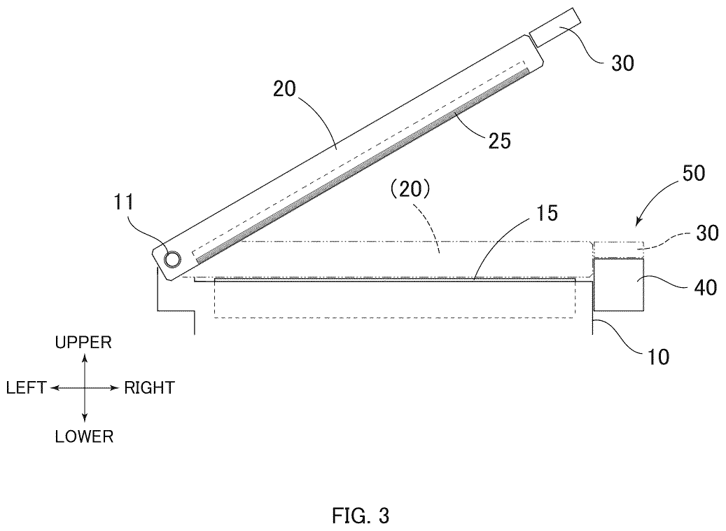

Hereinafter, an embodiment of the present disclosure will be described with reference to the drawings. FIG. 1 is a perspective view showing a configuration of a thermal printer according to an embodiment of the present disclosure. FIG. 2 is a front view showing a state in which a head cover is opened. FIG. 3 is a diagram schematically illustrating FIG. 2. FIG. 1 illustrates only main components of the thermal printer. In the following description, terms indicating directions such as “upper,” “lower,” “left,” and “right” are used in correspondence with the orientation of objects shown in the drawings, but these terms are not intended to be used in a limiting sense to interpret the present disclosure.

As shown in FIG. 1, a thermal printer S100 of the present embodiment includes a housing 10, a head cover 20, and a locking mechanism 50 as the main components. The thermal printer S100 is incorporated in a KIOSK terminal or a POS terminal, for example. The thermal printer S100 is a printing device that performs printing on a long sheet S drawn from a roll (not shown in figures).

The thermal printer S100 also includes a roll holder that holds the roll, a sheet cutting mechanism that cuts a printed sheet, a controller that controls the action of each unit, and the like. As conventionally known items can be used for these, a description thereof will be omitted.

### (Housing 10)

The housing 10 is formed in a box shape. The housing 10 is disposed on a base member 18 (see FIG. 1) constituting a lower portion of the thermal printer S100. Inside the housing 10, a platen roller 15 (see FIG. 3) is rotatably held, and a mechanism, a motor, and the like for rotating the platen roller 15 are disposed.

The platen roller 15 is located at the opposing side with respect to a thermal head 25 (described later in detail) with the sheet S interposed between them when the sheet S is set in the thermal printer S100. The platen roller 15 is a roller formed of an elastic material such as rubber. The platen roller 15 is disposed so as to extend in a direction (left-right direction in FIG. 3) perpendicular to the longitudinal direction of the sheet S. The platen roller 15 is rotated by power from the motor, not shown in figures. The platen roller 15 presses a print surface of the sheet toward the thermal head 25 and feeds the sheet by rotating. The sheet S fed by the platen roller 15 is ejected from the front surface (see FIG. 1) of the housing 10.

A support pin P2 is provided on a side surface of the housing 10. The support pin P2 extends in a direction parallel to the feeding direction of the sheet S.

### (Head Cover 20)

The head cover 20 is a cover disposed so as to cover an upper portion of the housing 10. As shown in FIG. 3, the head cover 20 is a member that supports the thermal head 25 via a heat sink. Specifically, the head cover 20 supports the thermal head 25 so that the thermal head 25 extends in the width direction of the sheet S.

The thermal head 25 is provided with a plurality of heating elements (not shown in figures) arranged in the width direction of the sheet. As a conventionally known item can be used as the thermal head 25, a detailed description thereof will be omitted. The thermal head 25 is controlled by a controller not shown in figures. Specifically, the thermal head 25 causes the plurality of heating elements to generate heat in accordance with a control signal transmitted from the controller, thereby performing printing on a sheet.

The head cover 20 is coupled to the housing 10 via a coupling pin 11 provided on one side of the housing 10 in the width direction (one side of the sheet S in the width direction). The head cover 20 is configured to open and close with respect to the housing 10. The head cover 20 is provided to move between an open position and a closed position about the coupling pin 11, which serves as a pivot point. FIG. 1 shows a state in which the head cover 20 is in the closed position. In this state, the thermal head presses the platen roller via the sheet S. The heating elements of the thermal head 25 apply heat to the sheet S, whereby predetermined characters, numbers, figures, or other images are printed on the sheet S.

As shown in FIGS. 2 and 3, when the head cover 20 is in the open position, the thermal head 25 is separated from the platen roller 15. In order to position the head cover 20 in the open position shown in FIGS. 2 and 3, a biasing member (not shown in figures) that applies a biasing force to the head cover 20 in a direction so that the head cover opens is provided. The biasing member may be a torsion spring disposed near the coupling pin 11, for example. The torsion spring may be arranged with the coupling pin 11 passed through the torsion spring. When a lock of the locking mechanism 50 is released, the head cover 20 is sprung up by the action of this torsion spring.

As shown in FIG. 2, the head cover 20 includes a lock pin P1. The lock pin P1 is provided at an end portion opposite to another end portion where the coupling pin 11 is provided. The lock pin P1 is disposed parallel to the coupling pin 11 and the support pin P2, and extends in the feeding direction of the sheet. The lock pin P1 is a round rod-shaped pin with which a claw of a lock member 40 of the locking mechanism 50, which will be described later, engages. The lock pin P1 and the support pin P2 are parallel to each other.

### (Locking Mechanism 50)

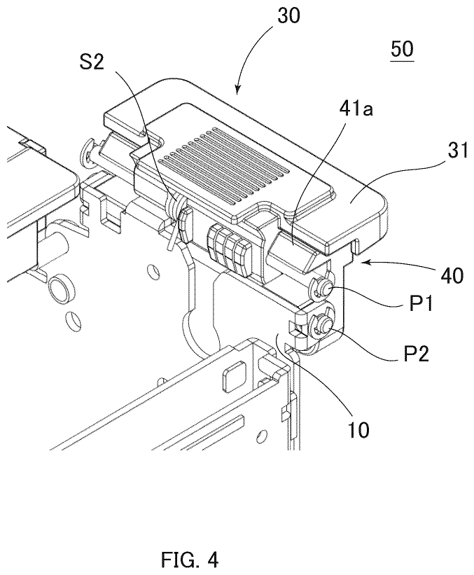

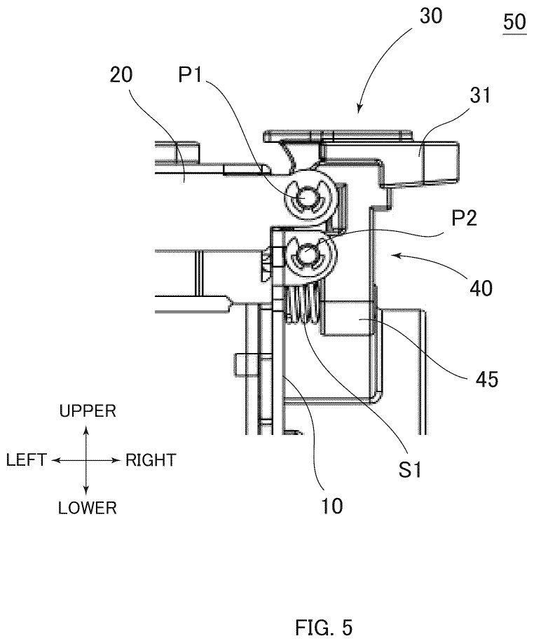

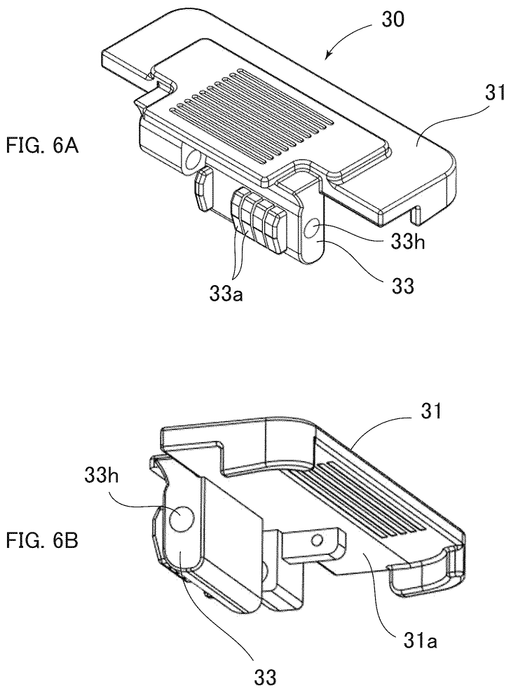

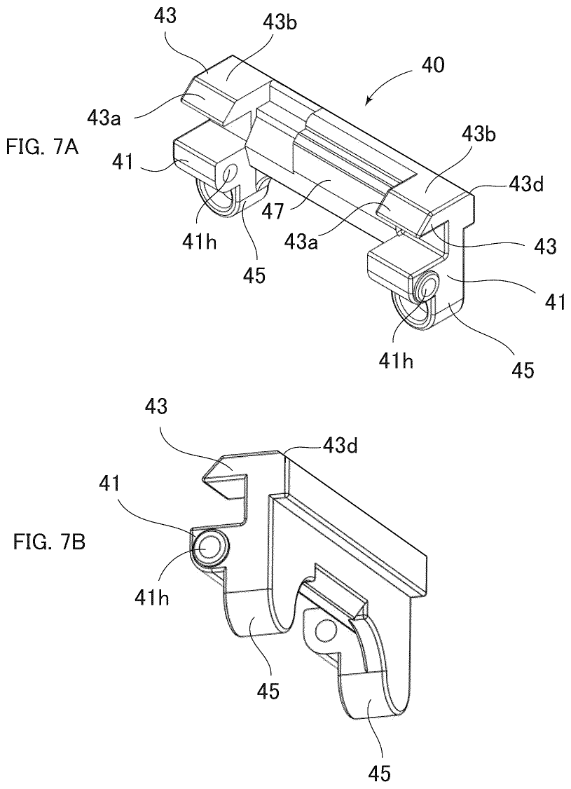

In the following, the locking mechanism 50 will be described in detail. FIG. 4 is a perspective view showing a peripheral structure of the locking mechanism. FIG. 5 is an enlarged view showing the peripheral structure of the locking mechanism. FIGS. 6A and 6B are perspective views of a lever member. FIGS. 7A and 7B are perspective views of the lock member. In FIG. 4, some components of the thermal printer are omitted to facilitate understanding of the configuration.

The locking mechanism 50 is a mechanism for locking the head cover 20 to the housing 10. The locking mechanism 50 in the locked state maintains the head cover 20 in the closed position. The locking mechanism 50 includes a lever member 30 and the lock member 40. Both of the lever member 30 and the lock member 40 is a resin molded product, for example. The lever member 30 and the lock member 40 may be made of metal or hard rubber.

The locking mechanism 50 is one of the characteristic features of the thermal printer S100. The locking mechanism 50 is configured to allow the lock to be released by either a pressing-down operation or a pulling-up operation of an operation part 31 (described later in detail) of the lever member 30. Depending on the shape or the like of a terminal into which the thermal printer S100 is incorporated, a problem may arise in that it may be difficult to operate if the lock can only be released by the pulling-up operation of the operation part 31 of the lever member 30, for example. However, according to the configuration of this embodiment, the lock can be released by either the pressing-down operation or the pulling-up operation of the operation part 31, thereby improving operability.

As shown in FIGS. 4 and 5, the lever member 30 is supported by the lock pin P1 of the head cover 20, and is provided to rotate about the lock pin P1. The lever member 30 in the locked state is attached to the head cover 20 in a posture so that the operation part 31 (described in detail later) extends in a horizontal direction.

A biasing force of a spring S2 (see FIG. 4), through which the lock pin P1 is inserted, is applied to the lever member 30. The spring S2 is a torsion spring, for example. When the operation part 31 is pressed down, the lever member 30 rotates clockwise (see FIG. 5) around the lock pin P1 against the biasing force of the spring S2. The spring S2 functions to return the lever member 30, which has rotated clockwise due to the pressing down of the operation part 31, to its original position as shown in FIG. 4. The spring S2 or other biasing member may be configured to return the lever member 30, which has rotated counterclockwise due to the pulling up of the operation part 31, to the position shown in FIG. 4

As shown in FIGS. 6A and 6B, the lever member 30 includes the operation part 31 and an extending part 33. The lever member 30 is formed in a substantially L-shape as a whole.

The operation part 31 is a plate-shaped portion operated by an operator. As understood from FIG. 1, the operation part 31 is provided so as to be located in a circumference of a top surface of the head cover 20 while the lever member 30 is attached to the head cover 20 (a state where the head cover 20 is in the closed position). Specifically, the operation part 31 is provided at an end portion of the head cover 20. As an example, the operation part 31 extends at the same height or substantially the same height as the top surface of the head cover 20. The operation part 31 may be provided at a position higher than or lower than the top surface of the head cover 20. In the state of FIG. 1, the operation part 31 extends in a direction perpendicular to the height direction of the thermal printer S100, for example. It is advantageous that the operation part 31 is provided in such a position that the operator can easily operate the operation part 31. A top surface of the operation part 31 may be a flat surface. The operation part 31 may have a concave top surface, which may be warped. The operation part 31 may have a convex top surface.

As shown in FIG. 6B, the operation part 31 includes a contact surface 31a. The contact surface 31a is provided on a bottom surface of the operation part 31. The contact surface 31a, details of which will be described later, is a portion that comes into contact with a portion of the lock member 40 when the operation part 31 is pressed down. This contact part corresponds to a “second contact part” of the present disclosure.

As illustrated in FIG. 6B, the extending part 33 is provided below the operation part 31. In this example, the extending part 33 extends in a direction orthogonal to the operation part 31. A through hole 33h through which the lock pin P1 is inserted is formed in the extending part 33. The lever member 30 is supported by the lock pin P1, which passes through the through hole 33h, and can rotate about the lock pin P1. As shown in FIG. 6A, a plurality of protruding portions 33a are formed in the extending part 33. The protruding portions 33a are portions that contact the side surface of the housing 10. The plurality of protruding portions 33a are provided in this example, but only a single protruding portion 33a need be provided. The extending part 33 extends at a position between a claw 43 (described in detail below) and another claw 43 of the lock member 40. A distal end portion of the extending part 33 is a contact part that is pressed against a portion of the lock member 40 when the lock is released.

As shown in FIG. 5, the lock member 40 is supported by the support pin P2 and can rotate about the support pin P2. As shown in FIGS. 7A and 7B, the lock member 40 includes a support part 41, the claw 43, and a spring holder 45.

The support part 41 is a portion having a through hole 41h through which the support pin P2 is inserted. The support part 41 is supported by the support pin P2.

The claw 43 is provided above the support part 41. The claw 43 is a portion that engages the lock pin P1 by hooking onto it. The claw 43 has an inclined surface 43a and a top surface 43b. The support part 41 is provided so as to protrude from a portion constituting a side surface of the lock member 40. In the present embodiment, a pair of claws 43 are provided as shown in FIG. 7A. One of the claws 43 (first claw) is a claw that engages a first position of the lock pin P1 in its longitudinal direction. Another one of the claws 43 (second claw) is a claw that engages a second position of the lock pin P1 in its longitudinal direction. In such a configuration, if the extending part 33 (the distal end portion of the extending part 33 is a contact part) for moving the lock member 40 is located between the two claws 43, a pressing force is applied to a position between the two claws 43. Therefore, for example, each claw 43 can be favorably disengaged from the lock pin P1 as compared with a configuration in which a position other than the position between the two claws 43 is pressed. Thus, a situation in which one claw 43 is disengaged from the lock pin P1 while another claw 43 remains engaged with the lock pin P1 is unlikely to occur.

The inclined surface 43a is, as will be described in detail later, a portion against which the lock pin P1 presses when the lock pin P1 is moved toward the lock member 40 due to the head cover 20 being pressed down. The inclined surface 43a is inclined in such a direction to generate a force in a direction that causes the claw 43 to disengage from the lock pin P1 when the lock pin P1 presses against the inclined surface 43a. The inclined surface 43a may be either a flat or curved surface, but in this example, the inclined surface 43a is flat.

The top surface 43b is, as will be described in detail later, a surface against which the contact surface 31a of the lever member 30 presses when the operation part 31 is pressed down and the lever member 30 rotates. The lock member 40 is configured so that when the top surface 43b is pressed by the contact surface 31a, the lock member 40 rotates and the claw 43 is disengaged from the lock pin P1 (details will be described later).

The spring holder 45 is provided below the support part 41. As shown in FIG. 5, the compression spring S1 is disposed in the spring holder 45. Specifically, the compression spring S1 is disposed in a compressed state between the spring holder 45 and the side surface of the housing 10 (see FIG. 5). As an example, the compression spring S1 is disposed in a concave portion formed as the spring holder 45. The concave portion has a cylindrical space, for example. In the case of such a shape, the compression spring S1 in the form of a coil spring can be favorably disposed in the concave portion. The compression spring S1 applies a biasing force to the lock member 40 in a direction causing the lock member 40 to rotate counterclockwise about the support pin P2. It should be noted that the compression spring S1 may be disposed to a convex portion (for example, a shaft-shaped member) provided on a predetermined support member, instead of the concave portion.

In the present embodiment, a pair of spring holders 45 are provided as shown in FIG. 7A. Specifically, as the spring holders 45, i) a spring holder 45 (first spring holder) located around an end of the support pin P2 and ii) a spring holder 45 (second spring holder) located around another end are provided. According to the configuration in which the spring holders 45 are formed around both ends of the support pin P2 and the compression spring S1 is disposed in each of the spring holders 45, the biasing force of the spring is applied to the lock member 40 in a well-balanced manner, so that the lock member 40 can be favorably operated.

### <Action of Locking Mechanism>

### (Locking Action)

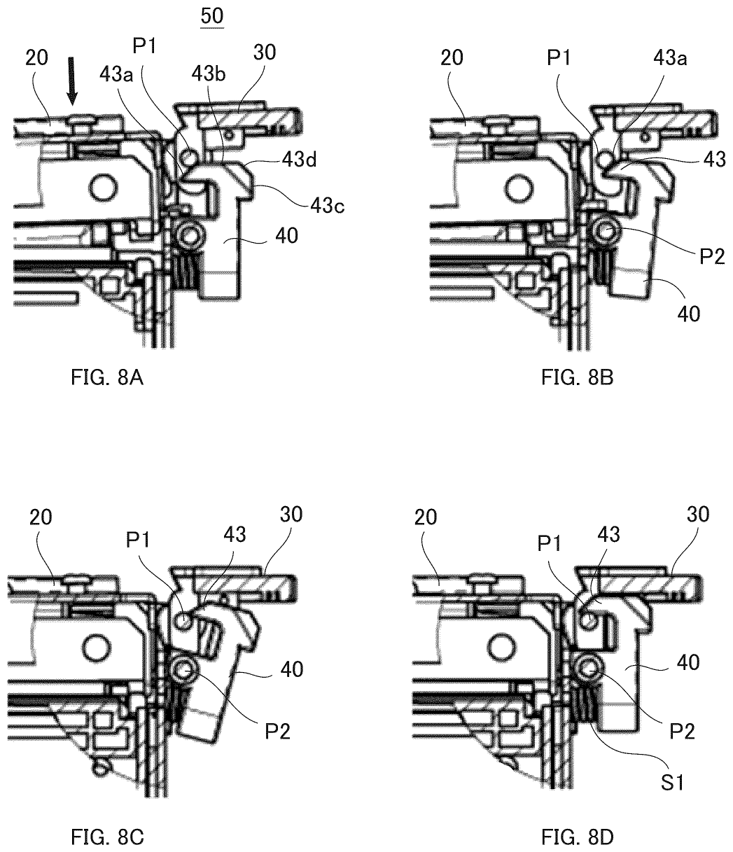

FIGS. 8A to 8D illustrate a locking action of the locking mechanism 50. In the locking mechanism 50 of the present embodiment, the operation of closing the head cover 20 can cause the locking mechanism 50 to be locked. This will be described in detail below. It should be noted that an inclined portion 43d, which is a chamfered portion, may be formed between the top surface 43b and a side surface 43c of the lock member 40, as illustrated in FIG. 8A. For example, the inclined portion 43d is inclined at an angle of 45° with respect to the top surface 43b.

As shown in FIG. 8A, when the head cover 20 is pressed down in the arrow direction, the lock pin P1 also moves downward toward the lock member 40 together with the head cover 20. The lock pin P1 then contacts the inclined surface 43a of the lock member 40.

As shown in FIG. 8B, when the head cover 20 is further pressed down in a state where the lock pin P1 is in contact with the inclined surface 43a, the lock pin P1 slides on the inclined surface 43a. As a result, the lock member 40 rotates clockwise about the support pin P2. That is, the lock member 40 rotates in a direction so that the claw 43 moves away from the lock pin P1.

As shown in FIG. 8C, when the head cover 20 is further pressed down, the claw 43 hooks onto the lock pin P1. Then, as shown in FIG. 8D, the lock member 40 rotates counterclockwise around the support pin P2 due to the action of the compression spring S1, and the claw 43 engages over the lock pin P1.

The locking mechanism 50 is locked through the above steps. According to the configuration of the present embodiment, the locking mechanism 50 can be brought into the locked state and the head cover 20 can be positioned in the closed position by the simple operation of pressing down the head cover 20. Accordingly, no complicated operation is required for locking.

### (First Operation for Releasing Lock)

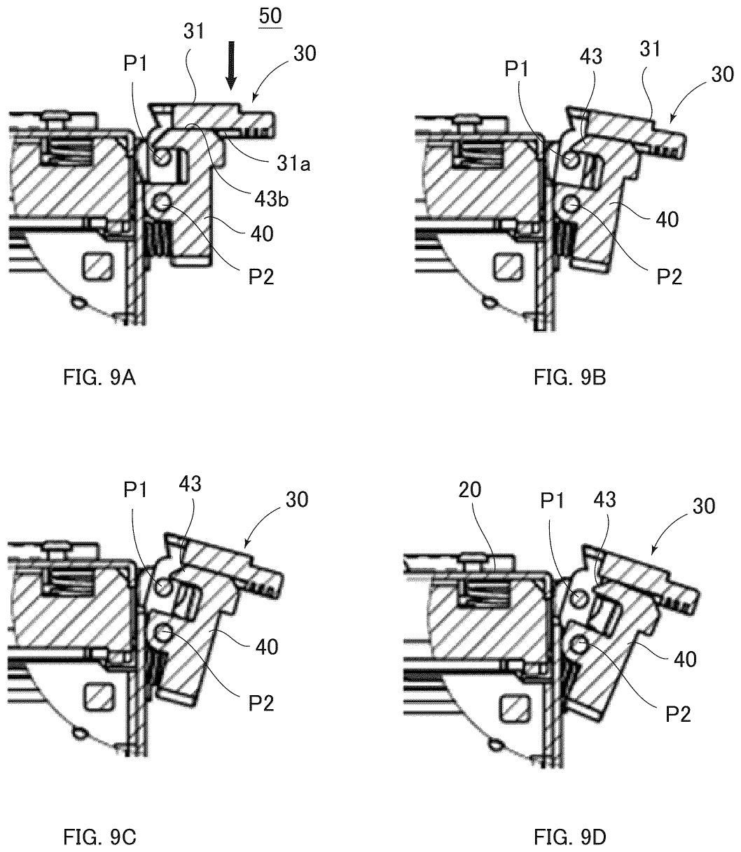

Next, with reference to FIGS. 9A to 9D, a description will be given regarding an operation for releasing the lock by pressing down the operation part 31. FIGS. 9A to 9D illustrate a first operation for releasing the lock. When the operation part 31, which is in the locked state of FIG. 9A, is pressed down as indicated by the arrow, the lever member 30 tends to rotate clockwise around the lock pin P1. As a result, the contact surface 31a of the lever member 30 is pressed against the top surface 43b of the lock member 40.

From this state, as the operation part 31 is further pressed down, the lever member 30 rotates clockwise about the lock pin P1 as shown in FIG. 9B. In conjunction with this movement, the lock member 40 also rotates clockwise about the support pin P2. That is, the lock member 40 rotates in a direction so that the claw 43 moves away from the lock pin P1.

From this state, as the operation part 31 is further pressed down, the lock member 40 rotates clockwise around the support pin P2 from the state shown in FIG. 9C to the state shown in FIG. 9D, causing the claw 43 to be disengaged from the lock pin P1, thereby releasing the lock. Subsequently, the head cover 20 is sprung up by the action of the biasing member (not shown in figures) provided on the head cover 20, and the head cover 20 opens as shown in FIG. 2.

Thus, in the locking mechanism 50 of the present embodiment, the lock of the locking mechanism 50 can be released by pressing down the operation part 31 of the lever member 30.

### (Second Operation for Releasing Lock)

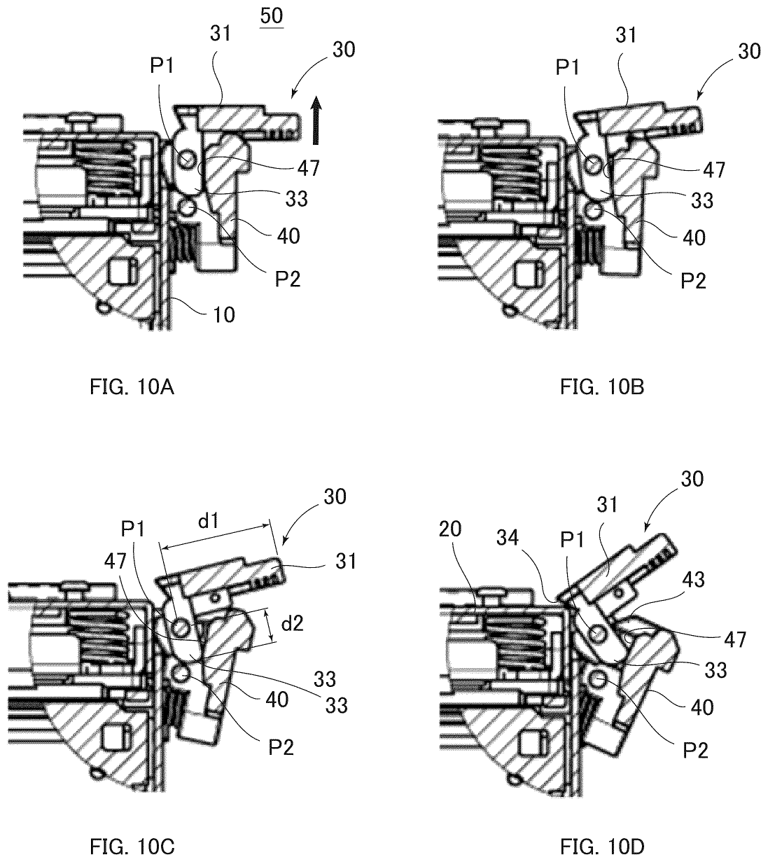

Next, with reference to FIGS. 10A to 10D, a description will be given regarding an operation for releasing the lock by pulling up the operation part 31. FIGS. 10A to 10D illustrate a second operation for releasing the lock. In the locked state of FIG. 10A, the extending part 33 of the lever member 30 is positioned farther inward (left side in the drawing) than the lock member 40. The extending part 33 is a member that forms a first contact part of the present disclosure, and extends downward from the operation part 31 between the side surface of the housing 10 and the inner surface 47 of the lock member 40.

The operation part 31 of the lever member 30 is pulled up by the operator's finger placing on the bottom surface of the operation part 31, for example.

When an attempt is made to pull up the operation part 31, the lever member 30 tends to rotate counterclockwise around the lock pin P1. As a result, the extending part 33 rotates counterclockwise about the lock pin P1, and a portion of the extending part 33 is pressed against the inner surface 47 of the lock member 40.

From this state, as the operation part 31 is further pulled up, the lever member 30 rotates counterclockwise about the lock pin P1 and the extending part 33 contacts the inner surface 47 to press that surface, whereby the lock member 40 rotates clockwise about the support pin P2, as shown in FIG. 10B.

From this state, as the operation part 31 is further pulled up, the lock member 40 moves clockwise about the support pin P2 from the state shown in FIG. 10C to the state shown in FIG. 10D, the lock member 40 rotates to a position similar to the position of the lock member 40 of FIG. 9D described above. As a result, the claw 43 is disengaged from the lock pin P1, thereby releasing the lock.

Then, similarly to the above, the head cover 20 is sprung up by the action of the biasing member (not shown in figures) provided to the head cover 20, and the head cover 20 opens.

As described above, in the locking mechanism 50 of the present embodiment, pulling up the operation part 31 of the lever member 30 also can release the lock of the locking mechanism 50. In the configuration of the present embodiment, as an example, the lever member 30 is configured so that a distance d1 is longer than a distance d2, as shown in FIG. 10C. The distance d1 is a distance from the center of the lock pin P1 to the end of the operation part 31. The distance d1 corresponds to a distance from the pivot point to the point of force application. The distance d2 is a distance from the center of the lock pin P1 to the first contact part (the distal end portion of the extending part 33). The distance d2 corresponds to the distance from the pivot point to the point of load application. According to such a configuration, a force greater than the force applied to the operation part 31 is applied to the lock member 40 by the lever principle, thereby achieving the effect of being able to release the lock with less effort.

It should be noted that, although not essential in the present disclosure, the lever member 30 may have a holding part 34 formed at the upper portion of the extending part 33, which may be provided to hold the head cover 20 that is about to be sprung up from above in the state shown in FIG. 10D. In this example, the holding part 34 is a protruding portion that contacts the top surface of the head cover 20 in the state shown in FIG. 10D. If the holding part 34 is provided as described above, the head cover 20 does not immediately open in the state shown in FIG. 10D. When the operator slightly returns the lever member 30 counterclockwise about the lock pin P1, the holding part 34 is disengaged from the head cover 20, allowing the head cover 20 to open.

### (Effects of Thermal Printer and Locking Mechanism)

As described above, in the locking mechanism 50 of the thermal printer S100 of the present embodiment, the lock of the locking mechanism 50 can be released by either the pressing-down operation or the pulling-up operation of the operation part 31 of the lever member 30. In particular, since the pressing-down operation and the pulling-up operation are performed on a single operation part 31, rather than on separate members, the structure does not become complex, and the operability for the operator is also improved. The thermal printer S100 is incorporated into various devices, including KIOSK terminals and POS terminals, to be used. Thus, according to this configuration where the lock can be released by a plurality of operations, the operator can release the lock of the locking mechanism 50 with an easy-to-operate action depending on the structure of the device in which the locking mechanism 50 is to be incorporated.

### <Modification 1>

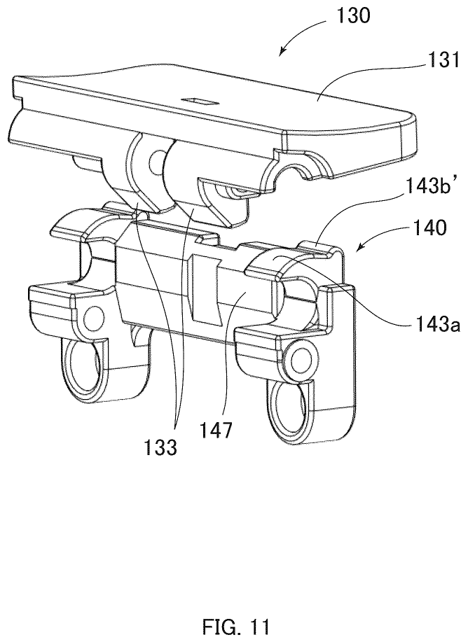

FIG. 11 shows a modification of the locking mechanism. In FIG. 11, reference numerals in the order of 100 are used, and the numerals correspond to those of the reference numerals in the embodiment described above.

As shown in FIG. 11, a lever member 130 includes an operation part 131. The operation part 131 is a member to be subjected to the pressing-down operation and the pulling-up operation, as in the above-described embodiment. The operation part 131 includes two extending parts 133. Each of the extending parts 133 is formed in a shape that presses an inner surface 147 of a lock member 140 as the operation part 131 rotates. The shape of the operation part 131 is arbitrary, and may be a slightly curved inclined surface as illustrated in FIG. 11, for example. A top surface of the operation part 131 may be formed with a plurality of projections such as rib-shaped or hemispherical projections so that when the operator's finger touches the surface, the operator can recognize that the location where the finger touches is the target of operation.

The lock member 140 has an inclined surface 143a as in the above embodiment. In the example of FIG. 11, a projection 143b′ is formed on the top surface of the lock member 140. The projection 143b′ has a substantially semicircular shape when viewed from the side, for example. With such a shape, the lock member 140 can favorably rotate while a contact surface (not shown in figures) formed on the operation part 131 is pressed against a projection 143b′.

### <Modification 2>

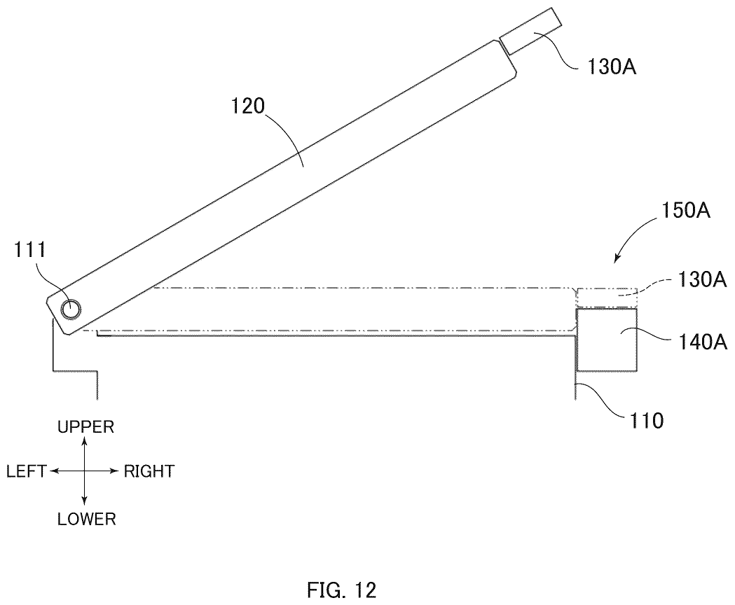

FIG. 12 schematically shows another usage example of the locking mechanism according to the present disclosure. In FIG. 12, reference numerals in the order of 100 are used, and the numerals correspond to those of the reference numerals in the embodiment described above. A locking mechanism 150A includes a lever member 130A and a lock member 140A. Since the structure and function of the locking mechanism 150A are the same as those of the above embodiment, detailed description thereof will be omitted.

In the above embodiment, the thermal head 25 is disposed in the head cover 20, and the platen roller 15 is disposed in the housing 10 (or vice versa). However, the locking mechanism 150A can be applied to various structures as long as a second member 120 rotates with respect to a first member 110. The first member 110 is a housing, for example, but is not limited thereto, and may be any member. The second member 120 is a cover or a lid, for example, but is not limited thereto, and may be any member. The components, devices, and the like accommodated in the first member 110 and the second member 120 also are not limited to specific components.

As described above, the locking mechanism 150A is a locking mechanism that locks the second member 120 to the first member 110, and includes i) the lever member 130A that is rotatably supported by the second member 120 and is formed with an operation part operated by the operator, and ii) the lock member 140A that maintains the second member 120 in the closed position.

### Another Configuration Example

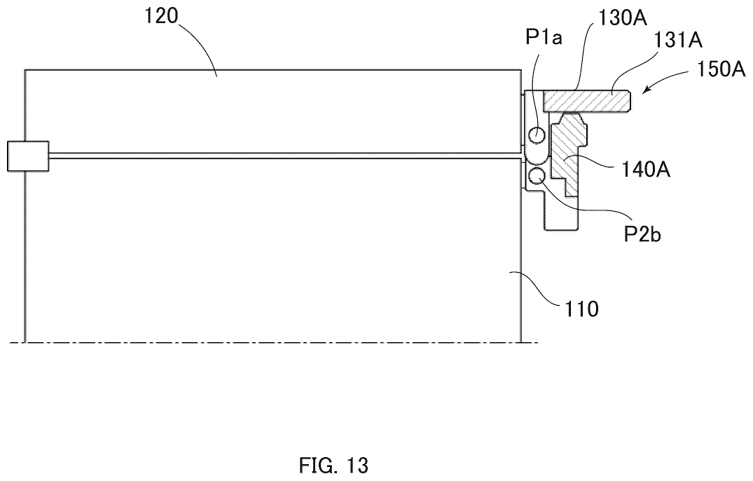

FIG. 13 is a schematic diagram illustrating another configuration example of the example of FIG. 12. The locking mechanism 150A may be configured as shown in FIG. 13. The locking mechanism 150A is a mechanism that secures the second member 120 to the first member 110. The locking mechanism 150A includes the lever member 130A and the lock member 140A.

The lever member 130A is a member that is formed with an operation part 131A operated by the operator. As an example, the lever member 130A is rotatably supported by the second member 120 via a first shaft P1a. The lever member 130A may be supported by a member different from the second member 120.

The lock member 140A is a member that is formed with a claw (not shown in figures) that engages the first shaft P1a. In this example, the lock member 140A is supported by the first member 110 via a second shaft P2a. The claw of the lock member 140A engages the first shaft P1a to maintain the second member 120 at the locked position.

The lever member 130A and the lock member 140A are configured, as in the above-described embodiment, so that (i) from the locked state in which the claw of the lock member 140A engages the first shaft P1a, as the operation part 131A of the lever member 130A moves in a first direction (for example, downward in FIG. 13), the lock member 140A rotates in a direction to move the claw away from the first shaft P1a and the lock is released by the claw being disengaged from the first shaft P1a. In addition, the lever member 130A and the lock member 140A are configured so that (ii) as the operation part 131A of the lever member 130A moves in a second direction (for example, upward in FIG. 13) opposite to the first direction, a portion of the lever member 130A presses the lock member 140A, whereby the lock member 140A rotates in a direction to move the claw away from the first shaft P1a and the lock is released by the claw being disengaged from the first shaft P1a.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

What is claimed is:

1. A thermal printer comprising:
a thermal head that performs printing on a long sheet drawn from a roll;
a platen roller that i) is located at an opposing side with respect to the thermal head with the sheet interposed between the platen roller and the thermal head and ii) feeds the sheet;
a housing that holds the platen roller so that the platen roller can rotate;
a cover that i) holds the thermal head, ii) is coupled to the housing so that the cover can be opened and closed about a pivot point at one side along the sheet in a width direction, and iii) is provided so as to move between a closed position where the thermal head contacts the platen roller and an opened position where the thermal head is separated from the platen roller; and
a locking mechanism that locks the cover to the housing; wherein
the locking mechanism includes:
a lever member that is rotatably supported by the cover and is formed with an operation part operated by an operator, and
a lock member, rotatably supported by the housing and formed with a claw engaging a lock pin of the cover, that maintains the cover in the closed position with the claw engaging the lock pin, and
the lever member and the lock member are configured so that i) as the operation part is pressed down, the lock member rotates in a direction to move the claw away from the lock pin, and the lock is released by the claw being disengaged from the lock pin and ii) as the operation part of the lever member is pulled up, a first contact part which is a portion of the lever member presses the lock member, whereby the lock member rotates in a direction to move the claw away from the lock pin, and the lock is released by the claw being disengaged from the lock pin.

2. The thermal printer according to claim 1, further comprising:
a biasing member that is configured to i) apply a biasing force to the cover in a direction to open the cover and ii) spring up the cover when the lock is released.

3. The thermal printer according to claim 1, wherein
a portion of the lever member is located between the lock member and the cover in the closed position, and
the lever member and the lock member are configured so that when the operation part is pulled up and the lever member is rotated, the first contact part presses the lock member in a direction to move the claw away from the lock pin, thereby disengaging the claw from the lock pin.

4. The thermal printer according to claim 3, wherein
the lever member is configured to rotate about the lock pin, and
a distance from a center of the lock pin to an end of the operation part is longer than a distance from the center of the lock pin to the first contact part.

5. The thermal printer according to claim 1, wherein
i) a first claw that engages a first position of the lock pin in a longitudinal direction, and
ii) a second claw that engages a second position of the lock pin in a longitudinal direction,
are provided as the claw, and
the first contact part is formed at a distal end of an extending part that extends at a position between the first claw and the second claw.

6. The thermal printer according to claim 1, wherein
the lever member has a second contact part that contacts the lock member when the operation part is pressed down, and
the lever member and the lock member are configured so that when the operation part is pressed down and the lever member is rotated, and the lock member is pressed by the second contact part, whereby the lock member is rotated and the claw is disengaged from the lock pin.

7. The thermal printer according to claim 1, wherein
the lock pin extends in a feeding direction of the sheet, and
the lock member has an inclined surface against which the lock pin, which moves towards the lock member when the cover is pressed down, presses, and is configured so that i) the lock pin slides on the inclined surface when the cover is pressed down while the lock pin is in contact with the inclined surface, whereby the lock member rotates in a direction to move the claw away from the lock pin and ii) the claw engages the lock pin when the cover is further pressed down.

8. The thermal printer according to claim 1, wherein
the locking member includes:
a support part that is supported by a support pin provided on a side surface of the housing,
the claw that is provided above the support part, and
a spring holder that is provided below the support part, wherein
a compression spring is disposed between the spring holder and the side surface of the housing, and the lock member is biased by the compression spring in a direction to cause the claw to be pressed against the locking pin.

9. The thermal printer according to claim 8, wherein
the support pin extends in a direction parallel to the feeding direction of the sheet, and
i) a first spring holder located on an end of the support pin, and
ii) a second spring holder located on another end of the support pin,
are provided as the spring holder.

10. The thermal printer according to claim 8, wherein
the lock pin and the support pin are disposed parallel to each other, and
the claw engages over the locking pin when the cover is in the closed position.

11. The thermal printer according to claim 1, wherein
the operation part is located at an end portion of the cover in a circumference of a top surface of the cover.

12. A locking mechanism for locking a cover to a housing in a printing device, the printing device comprising i) the housing that holds one of a thermal head and a platen roller for printing on a sheet and ii) a cover that holds another of the thermal head and the platen roller, and is coupled to the housing so that the cover can be opened and closed about a pivot point at one side along a sheet in a width direction, the locking mechanism comprising:
a lever member that is rotatably supported by the cover and is formed with an operation part operated by an operator; and
a lock member that is rotatably supported by the housing, is formed with a claw engaging a lock pin of the cover, and maintains the cover in a closed position with the claw engaging the lock pin, wherein
the lever member and the lock member are configured so that i) as the operation part is pressed down, the lock member rotates in a direction to move the claw away from the lock pin, and the lock is released by the claw being disengaged from the lock pin and ii) as the operation part of the lever member is pulled up, a portion of the lever member presses the lock member, whereby the lock member rotates in a direction to move the claw away from the lock pin, and the lock is released by the claw being disengaged from the lock pin.

13. A locking mechanism for locking a second member to a first member, comprising:
a lever member that is rotatably supported by the second member and is formed with an operation part operated by an operator; and
a lock member that is rotatably supported by the first member and is formed with a claw engaging with a first shaft of the second member, and maintains the second member in a closed position with the claw engaging the first shaft, wherein
the lever member and the lock member are configured so that
(i) from the locked state in which the claw engages the first shaft, as the operation part of the lever member moves in a first direction, the lock member rotates in a direction to move the claw away from the first shaft and the lock is released by the claw being disengaged from the first shaft, and
(ii) as the operation part of the lever member moves in a second direction opposite to the first direction, a portion of the lever member presses the lock member, whereby the lock member rotates in a direction to move the claw away from the first shaft and the lock is released by the claw being disengaged from the first shaft.
